(19) United States
(12) Patent Application Publication
(10) Pub. No.: US 2016/0083184 A1
(43) Pub. Date: Mar. 24, 2016

(54) TEMPERATURE CONTROLLED WASTE ITEM RECEPTACLE

(71) Applicants: Heena Rathore, Springboro, OH (US); Rakesh Rathore, Springboro, OH (US)

(72) Inventors: Heena Rathore, Springboro, OH (US); Rakesh Rathore, Springboro, OH (US)

(21) Appl. No.: 14/890,954

(22) PCT Filed: May 13, 2014
(86) PCT No.: PCT/US14/86367

§ 371 Date: Nov. 13, 2015

Related U.S. Application Data
(60) Provisional application No. 61/822,807, filed on May 13, 2013.

(51) Int. Cl. B65F 1/14; B65F 1/02

(52) U.S. Cl. CPC B65F 1/14; B65F 1/02; B65F 2210/20

(57) ABSTRACT

A temperature controlled waste item receptacle selects and maintains a temperature for contents based on the needs of an end user. A method and system provide support for controlling a temperature of contents disposed into a waste item receptacle. A controller selects a desired temperature of the contents disposed into the waste item receptacle. A temperature sensor senses a current temperature of the contents disposed into the waste item receptacle. The controller adjusts the current temperature of the contents disposed into the waste item receptacle to the desired temperature when a difference in the current temperature and the desired temperature exceeds a temperature threshold.

### CROSS-REFERENCE TO RELATED APPLICATIONS

This application claims the benefit of U.S. Application No. 61/822,807 filed on May 13, 2013 which is incorporated herein by reference in its entirety.

### FIELD OF THE INVENTION

The invention is generally related to waste item receptacles, and in particular to a temperature controlled waste item receptacle that selects and maintains contents based on the needs of an end user.

### BACKGROUND OF THE INVENTION

Contents discarded into waste item receptacles are any discarded materials that are abandoned and/or considered waste-like. The contents include but are not limited to any type of solid, liquid, semi-solid and/or gaseous materials. Contents also include but are not limited to items that are used and then discarded for disposition via landfill, recycling, and/or compost. In 2010, Americans generated approximately 250 million tons of contents. Contents are generated in society by but not limited to homes, schools, hospitals, businesses, municipality, government, and/or public places.

The Environmental Protection Agency (EPA) and/or other regulatory authorities classify contents into various categories. For example, an ignitable hazardous waste category includes ignitable wastes that can readily catch fire and/or sustain combustion. A corrosive hazardous waste category includes corrosive wastes that are acidic wastes and/or alkaline wastes that can readily corrode and/or dissolve flesh, metal, and/or other materials. Sulfuric acid waste generated by automotive batteries is included in the corrosive hazardous waste category. A reactive hazardous waste category includes reactive wastes that can readily explode and/or can undergo violent reactions. Discarded munitions and/or explosives are included in the reactive hazardous waste category. A toxicity characteristic waste includes toxicity characteristic wastes that are based on leachate derived from lab procedures classified as Toxicity Characteristic Leaching Procedures (TCLP).

Contents classified into one of the hazardous waste categories noted above can result in disease and/or serious injury if not handled properly. Conventional tests and/or methods have been developed to identify the classification of hazardous waste for the contents and the protection required for the contents. However, such conventional tests and/or methods fail to evaluate the potential of the contents to explode and/or react violently under common handling conditions. Such conventional tests and/or methods fail to take into account the temperature in which the contents should be maintained to avoid explosion and/or violent reactions caused by the contents. Thus, individuals who handle contents classified as hazardous waste are at a higher risk of harm when the temperature of such contents is not accounted for.

For example, some contents classified as hazardous contents become explosive when exposed to warmer temperatures. Disposed batteries become charged in warmer temperatures and can explode. Bacteria, cells, and/or insects associated with contents classified as hazardous contents grow at a faster rate when such contents are exposed to warmer temperatures.

Issues are also associated with contents not classified as hazardous contents, such as food wastes for example, when the temperatures of such contents are not accounted for. For example, contents not classified as hazardous waste items generate unhygienic odor, bacterial infections, and/or insects when exposed to warmer temperatures. Thus, individuals who handle contents not classified as hazardous contents are at a higher risk of being unsanitary when the temperatures of such contents are not accounted for.

Conventionally, waste item receptacles that house contents until the contents can be properly disposed of are not temperature controlled. The temperature of the contents housed in the waste item receptacles corresponds to the ambient temperature of the environment that waste item receptacles are placed. As the ambient temperature reaches a threshold in which the contents are put into a hazardous and/or unsanitary state, conventional methods do not adjust the temperature of the contents to prevent the contents from reaching the hazardous and/or unsanitary state. Rather, the contents remain in the hazardous and/or unsanitary state until the ambient temperature moves away from the threshold.

A need therefore continues to exist in the art for an improved manner of controlling the temperature of the contents housed in waste item receptacles.

### SUMMARY OF THE INVENTION

The invention addresses these and other problems associated with the prior art by providing a temperature controlled waste item receptacle that selects and maintains a temperature for contents based on requirements of an end user. Contents discarded into a waste item receptacle are any discarded materials that are abandoned and/or considered waste-like. Contents can include but are not limited to any type of solid, liquid, semi-solid and/or gaseous materials. In many embodiments consistent with the invention, a temperature sensor may continuously sense a current temperature from within the waste item receptacle. A controller coupled to the temperature sensor may then maintain a controlled temperature from within the waste item receptacle in response to the sensed current temperature to inhibit the contents of the waste item receptacle from reaching a hazardous and/or unsanitary state. Therefore, consistent with one aspect of the invention, a system includes a temperature sensor is configured to sense a current temperature from within a waste item receptacle A controller is configured to maintain a controlled temperature from within the waste item receptacle in response to the sensed current temperature to inhibit the contents of the waste item receptacle from reaching a hazardous and/or unsanitary state.

Further features and advantages of the invention, as well as the structure and operation of various embodiments of the invention, are described in detail below with reference to the accompanying drawings. The invention is not limited to the specific embodiments described herein. The embodiments are presented for illustrative purposes only and so that readers will have multiple views enabling better perception of the invention, which is broader than any particular embodiment. Additional embodiments will be apparent to persons skilled in the relevant art(s) based on the teachings set forth in this patent document.

### BRIEF DESCRIPTION OF THE DRAWINGS

The accompanying drawings, which are incorporated herein and form part of the specification, illustrate the present invention and, together with the description, further serve to explain the principles of the present invention and to enable a person skilled in the pertinent art to make and use the present invention. Various embodiments of the present invention are described below with reference to the drawings, wherein like reference numerals are used to refer to like elements throughout.

FIG. 1 is a block diagram of an exemplary automated system for controlling a temperature of contents disposed in a waste item receptacle, in accordance with embodiments of the present invention.

FIG. 2 shows a flowchart illustrating a method for controlling a temperature of contents disposed in a waste item receptacle, in accordance with embodiments of the present invention.

### DETAILED DESCRIPTION

Embodiments consistent with the invention provide a temperature controlled waste item receptacle that selects and maintains contents based on requirements of an end user. Contents may be any discarded materials that are abandoned and/or considered waste-like. Contents may include any type of solid liquid, semi-solid, gaseous materials, and/or any other type of chemical structure as will occur to those of skill in the art. a temperature sensor may be configured to sense a current temperature from within the waste item receptacle. The temperature sensor may sense when the current temperature from within the waste item receptacle fluctuates away from a desired temperature of the waste item receptacle. Fluctuation of the current temperature from within the waste item receptacle of the from the desired temperature of the waste item receptacle may increase the risk of the contents reaching a hazardous and/or unsanitary state. For example, in some embodiments it may be desirable to maintain a desired temperature of a disposed battery at about 50 degrees Fahrenheit, considering that some types of batteries run a significant risk of exploding at about 90 degrees Fahrenheit. The temperature sensor senses when the current temperature from within the waste item receptacle drifts away from 50 degrees Fahrenheit and approaches 90 degrees Fahrenheit.

A controller may maintain a controlled temperature from within the waste item receptacle in response to the sensed current temperature to inhibit the contents from reaching the hazardous and/or unsanitary state. The controller may maintain the controlled temperature within a temperature threshold of a desired temperature of the waste item receptacle. The temperature threshold may be a difference in temperature between the current temperature of the waste item receptacle and the desired temperature of the waste item receptacle in which such a difference may increase the risk that the contents reach a hazardous and/or unsanitary state. The controller may maintain the controlled temperature to a temperature that is within the temperature threshold so that the controlled temperature is closer to the desired temperature. Maintaining the controlled temperature to within the temperature threshold may prevent the contents from reaching a hazardous and/or unsanitary state.

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “embodiments of the invention” does not require that all embodiments of the invention include the discussed feature, advantage or mode of operation. Alternate embodiments may be devised without departing from the scope of the invention, and well-known elements of the invention may not be described in detail or may be omitted so as not to obscure the relevant details of the invention. In addition, the terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

In addition, functionality associated with the various embodiments disclosed herein may be described in terms of being implemented in modules. A module, in this regard, may include hardware, software or a combination thereof implementing the described functionality. Moreover, it will be appreciated that the functionality of a module may be implemented by multiple modules in some embodiments, and that the functionality of multiple modules may be combined into a common module in some embodiments. Therefore, the invention is not limited to the particular organization of modules described herein.

### Hardware and Software Environment

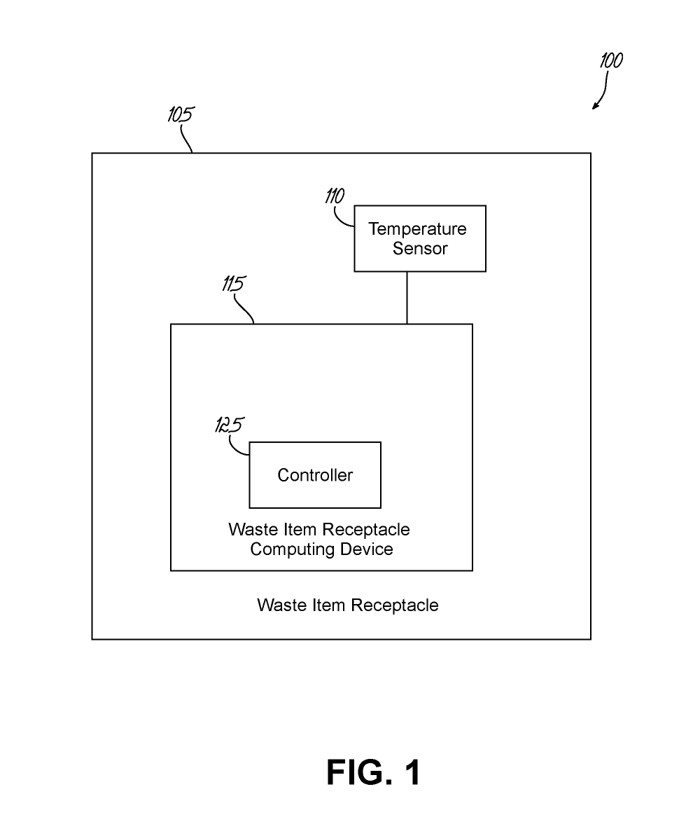

Turning now to FIG. 1, this figure illustrates a waste item receptacle temperature control system 100 where a temperature of contents disposed into a waste item receptacle is controlled. Waste item receptacle control system includes a waste item receptacle 105. Waste item receptacle 105 includes a temperature sensor 110 and a waste item receptacle computing device 115. Sold waste receptacle computing device 115 includes a controller 125.

The contents disposed in waste item receptacle 105 may enter a hazardous and/or unsanitary state when the current temperature of the contents reaches an agitation temperature. The agitation temperature of the contents may be a temperature of the contents that when reached may increase the risk that the contents becomes agitated and enters the hazardous and/or unsanitary state. The contents may become hazardous and/or unsanitary to individuals within proximity of waste item receptacle 105 when agitated. Controller 125 may select a desired temperature of the contents disposed into waste item receptacle 105. The desired temperature of the contents may be a temperature of the contents that ensures the contents does not become agitated and enter the hazardous and/or unsanitary state. For example, the battery disposed in waste item receptacle 105 becomes agitated with an increased risk of explosion when the temperature of the battery disposed in waste item receptacle 105 reaches 90 degrees Fahrenheit. In order to prevent the battery disposed in waste item receptacle 105 from reaching the agitated state, the desired temperature of 60 degrees Fahrenheit is selected for the battery to ensure the battery does not reach the agitated state associated with 90 degrees Fahrenheit.

In an embodiment, controller 125 may be centralized and configured to select a desired temperature for a plurality of waste item receptacles that includes waste item receptacle 105. Controller 125 may be centralized in that controller 125 is not located on each waste item receptacle but is located at a central location and selects the desired temperature for each of the waste item receptacles from that central location. Controller 125 may select an overall desired temperature for the plurality of waste item receptacles where controller 125 selects a single desired temperature that each of the waste item receptacles is configured to. For example, controller 125 may select a single desired temperature of 60 degrees Fahrenheit for the plurality of waste item receptacles so that the desired temperature for each of the waste item receptacles is 60 degrees Fahrenheit.

In an embodiment, controller 125 may select a customized desired temperature for the plurality of contents disposed into each waste item receptacle. Each customized desired temperature may be selected based on the contents disposed into each waste item receptacle. For example, the battery is disposed in waste item receptacle 105. Controller 125 selects a customized desired temperature of 60 degrees Fahrenheit for waste item receptacle 105 to prevent the battery from becoming agitated with an increased risk of explosion. The baby diaper is disposed into a second waste item receptacle. Controller 125 selects a customized desired temperature of 70 degrees Fahrenheit for the second waste item receptacle to prevent the baby diaper from becoming agitated and generating an unhygienic odor.

In an embodiment, a plurality of controllers that includes controller 125 may be local to each waste item receptacle in that each controller corresponds to each waste item receptacle. Each controller may select a customized desired temperature for the contents disposed into each corresponding waste item receptacle. For example, the battery is disposed in waste item receptacle 105. Controller 125 is local to waste item receptacle 150 and selects the customized desired temperature of 60 degrees Fahrenheit for waste item receptacle 105 to prevent the battery from becoming agitated with an increased risk of explosion. The baby diaper is disposed in the second waste item receptacle. The second controller 125 is local to the second waste item receptacle and selects the customized desired temperature of 70 degrees Fahrenheit for the second waste item receptacle to prevent the baby diaper from becoming agitated and generating an unhygienic odor.

Temperature sensor 110 may be configured to sense a current temperature of the contents disposed in waste item receptacle 105. Temperature sensor 110 may sense when the current temperature of the contents disposed into waste item receptacle 105 fluctuates away from the desired temperature of the contents that was selected by controller 125. Fluctuation of the current temperature of the contents from the desired temperature of the contents selected by controller 125 may increase the risk of the contents becoming agitated and reaching a hazardous and/or unsanitary state. For example, the battery is disposed in waste item receptacle 105. The desired temperature of the battery is 60 degrees Fahrenheit as selected by controller 125. The temperature of the battery in which the battery may become agitated with an increased risk of explosion is 90 degrees Fahrenheit. Temperature sensor 110 senses when the current temperature of the disposed battery drifts away from 60 degrees Fahrenheit and approaches 90 degrees Fahrenheit.

In an embodiment, temperature sensor 110 may be centralized and configured to sense a plurality of current temperatures from the plurality of contents disposed into the plurality of waste item receptacles that include waste item receptacle 105. Temperature sensor 110 may be centralized in that temperature sensor 110 is not located on each waste item receptacle but is located at a central location. A sensor may be located locally on each waste item receptacle. Each local sensor may sense each current temperature for the contents disposed in each waste item receptacle. Each local sensor may then report each sensed current temperature of the contents disposed in each waste item receptacle to temperature sensor 110.

Temperature sensor 110 may then collectively sense the plurality of current temperatures of the contents disposed into the plurality of waste item receptacles. Sensing module 110 may recognize when a current temperature associated with a waste item receptacle deviates away from the single desired temperature selected by controller 125 for the plurality of waste item receptacles. For example, temperature sensor 110 may sense when the current temperature for waste item receptacle 105 deviates away from the single desired temperature of 60 degrees Fahrenheit for the plurality of waste item receptacles based on the current temperature reported to temperature sensor 110 by the sensor located on waste item receptacle 105.

As noted above, each customized desired temperature may be selected by controller 125 based on the contents disposed into each waste item receptacle. In an embodiment, temperature sensor 110 may then sense when the current temperature of each waste item receptacle deviates away from each customized desired temperature selected by controller 125 for each waste item receptacle.

For example, the battery is disposed in waste item receptacle 105. Controller 125 selects a customized desired temperature of 60 degrees Fahrenheit for waste item receptacle 105 to prevent the battery from becoming agitated with an increased risk of explosion. Temperature sensor 110 senses when the current temperature of battery deviates away from 60 degrees Fahrenheit and comes closer to the temperature in that the battery becomes agitated with an increased risk of explosion. The baby diaper is disposed into the second waste item receptacle. Controller 125 selects the customized desired temperature of 70 degrees Fahrenheit for the second waste item receptacle to prevent the baby diaper from becoming agitated and generating an unhygienic odor. Temperature sensor 110 senses when the current temperature of the baby diaper deviates away from 70 degrees Fahrenheit and comes closer to the temperature in that the baby diaper becomes agitated and generates an unhygienic odor.

In an embodiment, a plurality of temperature sensors that includes temperature sensor 110 may be local to each waste item receptacle in that each temperature sensor corresponds to each waste item receptacle. Each temperature sensor may sense when the current temperature for the contents items disposed into each waste item receptacle deviates away from the customized desired temperature selected by controller 125 for the contents disposed into each corresponding waste item receptacle. For example, the battery is disposed in waste item receptacle 105. Temperature sensor 110 is local to waste item receptacle 105 and senses when the current temperature of the battery deviates away from the customized desired temperature of 60 degrees Fahrenheit for waste item receptacle 105. The baby diaper is disposed in the second waste item receptacle. The second temperature sensor is local to the second waste item receptacle and senses when the current temperature of the baby diaper deviates away from the customized desired temperature of 70 degrees Fahrenheit for the second waste item receptacle.

Controller 125 may adjust the current temperature of the contents disposed in waste item receptacle 105 sensed by temperature sensor 110 to the desired temperature selected by controller 125 when a difference in the current temperature and the desired temperature exceeds a temperature threshold. The temperature threshold may be a difference in temperature between the current temperature of the contents as sensed by temperature sensor 110 and the desired temperature of the contents as selected by controller 125. Such a threshold difference may increase the risk that the contents becomes agitated and reaches a hazardous and/or unsanitary state. Controller 125 may adjust the current temperature of the contents to a temperature that is within the temperature threshold so that the current temperature of the contents is closer to the desired temperature. Controller 125 adjusting the current temperature to within the temperature threshold may prevent the contents from reaching a hazardous and/or unsanitary state.

For example, the battery is disposed in waste item receptacle 105. The temperature threshold for the disposed battery is a 20 degree difference from the desired temperature selected by controller 125. The desired temperature of the disposed battery as selected by controller 125 is 60 degrees Fahrenheit. The current temperature of the disposed battery as sensed by temperature sensor 110 reaches 81 degrees Fahrenheit. The temperature threshold of 20 degree difference for the battery has been exceeded. Controller 125 then adjusts the current temperature of the current battery as sensed by temperature sensor 110 to 60 degrees Fahrenheit.

In an embodiment, controller 125 may be centralized and configured to adjust a plurality of current temperatures from the plurality of contents disposed into the plurality of waste item receptacles that includes waste item receptacle 105. Controller 125 may be centralized in that controller 125 is not located on each waste item receptacle but is located at a central location. Controller 125 may collectively adjust the plurality of current temperatures of the contents disposed into the plurality of waste item receptacles when the difference in one of the current temperatures and the single desired temperature selected by controller 125 exceeds the temperature threshold.

For example, the single desired temperature selected by controller 125 for the contents disposed in waste item receptacle 105 and the contents disposed in the second waste item receptacle is 60 degrees Fahrenheit. The temperature threshold for the contents disposed in waste item receptacle 105 and the contents disposed in the second waste item receptacle is 20 degrees. The difference in the current temperature of the contents disposed in waste item receptacle 105 and the single desired temperature is 21 degrees while the difference in the current temperature of the contents disposed in the second solid waste receptacle and the single desired temperature is 15 degrees. Controller 125 adjusts the current temperature of the contents disposed in waste item receptacle 105 and the contents disposed in the second waste item receptacle to 60 degrees Fahrenheit.

As noted above, each customized desired temperature may be selected by controller 125 based on contents disposed into each solid item waste receptacle. In an embodiment, controller 125 may then adjust the current temperature of contents disposed in each waste item receptacle that deviates way from each customized desired temperature selected by controller 125 for each waste item receptacle. Controller 125 refrains from adjusting the current temperature of contents disposed in each waste item receptacle that is within the temperature threshold of each customized desired temperature for each waste item receptacle.

For example, the battery is disposed in waste item receptacle 105. Controller 125 selects a customized desired temperature of 60 degrees Fahrenheit for waste item receptacle 105 to prevent the battery from becoming agitated with an increased risk of explosion. Temperature sensor 110 senses when the current temperature of the battery deviates away from 60 degrees Fahrenheit and comes closer to the temperature in that the battery becomes agitated with an increased risk of explosion.

The baby diaper is disposed into the second waste item receptacle. Controller 125 selects the customized desired temperature of 70 degrees Fahrenheit for the second waste item receptacle to prevent the baby diaper from becoming agitated and generating an unhygienic odor. Temperature sensor 110 does not sense that the current temperature of the second waste item receptacle has deviated away from the customized desired temperature of 70 degrees Fahrenheit so that the baby diaper is not agitated and is not generating an unhygienic odor.

Controller 125 adjusts the current temperature for waste item receptacle 105 to 60 degrees Fahrenheit to ensure the battery does not become agitated to eliminate the risk of explosion. However, controller 125 refrains from adjusting the current temperature for the second waste item receptacle because the current temperature is still within the temperature threshold of the customized desired temperature for the second waste item receptacle of 70 degrees Fahrenheit.

In an embodiment, a plurality of controller that includes controller 125 may be local to each waste item receptacle in that each controller corresponds to each waste item receptacle. Each controller may adjust the current temperature of each waste item receptacle to the customized desired temperature when the difference in each current temperature and each customized selected temperature for each waste item receptacle exceeds the temperature threshold. For example, the battery is disposed in waste item receptacle 105. Controller 125 is local to waste item receptacle and adjusts the current temperature of waste item receptacle 105 when the current temperature of the battery deviates away from the customized desired temperature of 60 degrees Fahrenheit for waste item receptacle 105. The baby diaper is disposed in the second waste item receptacle. The second controller is local to the second solid item waste receptacle and adjusts the current temperature of the second waste item receptacle when the current temperature of the baby diaper deviates away from the customized desired temperature of 70 degrees Fahrenheit for the second waste item receptacle.

Controller 125 may prevent the contents from combusting by maintaining the current temperature of the contents within the temperature threshold of the desired temperature of the contents. As noted above, contents, such as a battery for example, have an increased risk of combustion and/or explosion when the current temperature of the battery exceeds the temperature threshold of the desired temperature of the battery. Controller 125 may adjust the current temperature of the battery so that the current temperature is lowered to within the temperature threshold of the desired temperature of the battery.

Controller 125 may accelerate composting of the contents by maintaining the current temperature of the contents within the temperature threshold of the desired temperature of the contents. Waste item receptacle 105 may store contents that are to be disposed of via a composting disposition method until the contents is delivered to a composition disposition facility that disposes of the contents via the composting disposition method. Compostable contents may slow down the compost process when the contents have a cool current temperature when the composting disposition method begins. As a result, the desired temperature for the compostable contents selected by controller 125 is a temperature that is sufficiently warm to accelerate the composting process of the compostable contents. Controller 125 may adjust the current temperature of the compostable contents so that the current temperature is increased to within the temperature threshold of the desired temperature of the compostable contents to accelerate the composting of the compostable contents.

Controller 125 may generate warm air to maintain the current temperature of the contents to within the temperature threshold of the desired temperature over an extended period of time from a plug-in heat source that may be plugged into the waste item receptacle. The plug-in heat source may generate warm air over the extended period of time as the current temperature fluctuates from the desired temperature. As noted above, controller 125 may adjust the current temperature of the contents as sensed by temperature sensor 110 by raising the current temperature of the contents to within the temperature threshold of the contents when the current temperature drops below the desired temperature. Controller 125 may raise the current temperature of the contents by generating warm air into waste item receptacle 105. The warm air generated into waste item receptacle 105 may raise the current temperature of the contents disposed in waste item receptacle 105.

Waste item receptacle 105 may be plugged into a plug-in heat source. Controller 125 may generate the warm air to raise the current temperature of the contents by adjusting the amount of warm air generated by the plug-in heat source into waste item receptacle 105. The plug-in heat source may be designed to generate warm air as requested by controller 125 over an extended period of time. The plug-in heat source may be a permanent fixture that plugs into waste item receptacle 105. The plug-in heat source may not travel with waste item receptacle 105 when waste item receptacle 105 is removed from the plug-in heat source and moved to another location.

For example, organic waste items are disposed into waste item receptacle 105. Waste item receptacle 105 is plugged into the plug-in heat source located in the medical lab in which the organic waste items are being disposed into waste item receptacle 105. The plug-in heat source generates warm air into waste item receptacle 105 to maintain the current temperature of the organic waste items within the temperature threshold of the medical waste items to ensure the current temperature does not deviate too far from the desired temperature. The plug-in heat source continues to maintain the current temperature of the medical waste items by generating the warm air over an extended period of time until waste item receptacle 105 is removed from the plug-in heat source. Waste item receptacle 105 is then transferred to a solid waste facility to permanently dispose of the organic waste items while the plug-in heat source remains in the cafeteria.

Controller 125 may generate cool air to maintain the current temperature of the contents to within the temperature threshold of the desired temperature over the extended period of time from a plug-in cooling source that may be plugged into the waste item receptacle. The plug-in cooling source may generate cool air over the extended period of time as the current temperature fluctuates from the desired temperature. As noted above, controller 125 may adjust the current temperature of the contents as sensed by temperature sensor 110 by lowering the current temperature of the contents to within the temperature threshold of the contents when the current temperature is raised above the desired temperature. Controller 125 may lower the current temperature of the contents by generating cool air into waste item receptacle 105. The cool air generated into waste item receptacle 105 may lower the current temperature of the contents disposed in waste item receptacle 105.

Waste item receptacle 105 may be plugged into a plug-in cooling source. Controller 125 may generate the cool air to lower the current temperature of the contents by adjusting the amount of cool air generated by plug-in cooling source into waste item receptacle 105. The plug-in cooling source may be designed to generate cool air as requested by controller 125 over an extended period of time. The plug-in cooling source may be a permanent fixture that plugs into waste item receptacle 105. The plug-in cooling source may not travel with waste item receptacle 105 when waste item receptacle 105 is removed from the plug-in cooling source and moved to another location.

Controller 125 may generate warm air to maintain the current temperature of the contents to within the temperature threshold of the desired temperature over a shortened period of time from a portable heat source. Waste item receptacle 105 may be coupled to portable heat source. Controller 125 may generate warm air to raise the current temperature of the contents by adjusting the amount of warm air generated by the portable heat source into waste item receptacle 105. The portable heat source may be designed to generate warm air over as requested by controller 125 over a shortened period of time. The portable heat source may accompany waste item receptacle 105 as waste item receptacle 105 is moved. The portable heat source may generate warm air into waste item receptacle 105 when waste item receptacle is no longer plugged into the plug-in heat source. The portable heat source may refrain from generating warm air into waste item receptacle 105 when waste item receptacle 105 is plugged into the plug-in heat source.

For example, organic waste items are disposed into waste item receptacle 105. Waste item receptacle 105 is plugged into the plug-in heat source located in the medical lab in which the organic waste items are being disposed into waste item receptacle 105. The plug-in heat source generates warm air into waste item receptacle 105 while waste item receptacle 105 is plugged into the plug-in heat source. The portable heat source, may be battery operated for example, remains idle while waste item receptacle 105 is plugged into the plug-in heat source. Waste item receptacle 105 is removed from the plug-in heat source to transfer waste item receptacle 105 to a solid waste facility to permanently dispose of the medical waste items. The plug-in heat source remains in the medical lab while the portable heat source travels with waste item receptacle 105. The portable heat source generates warm air into waste item receptacle 105 while waste item receptacle 105 is transferred to maintain the current temperature of the medical waste items within the temperature threshold of the medical waste items to ensure the current temperature does not deviate too far from the desired temperature.

Controller 125 may generate cool air to maintain the current temperature of the contents to within the temperature threshold of the desired temperature over a shortened period of time from a portable cooling source. Waste item receptacle 105 may be coupled to the portable cooling source. Controller 125 may generate cool air to lower the current temperature of the contents by adjusting the amount of cool air generated by portable cooling source into waste item receptacle 105. The portable cooling source may be designed to generate cool air into waste item receptacle 105. The portable cooling source may accompany waste item receptacle 105 as waste item receptacle 105 is moved. The portable cooling source may generate cool air into waste item receptacle 105 when waste item receptacle 105 is no longer plugged into the plug-in cooling source. The portable cooling source may refrain from generating cool air into waste item receptacle 105 when waste item receptacle 105 is plugged into the plug-in cooling source.

Waste item receptacle 105 may be associated with a landfill disposition method where the contents are disposed into waste item receptacle 105 are disposed of in a landfill. Sold waste receptacle 105 may be associated with a recycling disposition method where the contents are disposed into waste item receptacle 105 are capable of being recycled and are disposed of in a recycling center. Waste item receptacle 105 may be associated with compositing disposition method where the contents are disposed into waste item receptacle 105 are capable of being composted and are disposed of in a composting center. Waste item receptacle 105 may be associated with the landfill disposition method, the recycling disposition method, the composting disposition method and/or any other disposition method of contents items as will occur to those of skill in the art.

In an embodiment, waste item receptacle 105 may include a solar cell capable of powering the waste item receptacle 105 via solar energy. In such an embodiment, temperature sensor 110 and/or waste item receptacle computing device 115 may be powered via solar energy generated by the solar cell coupled to waste item receptacle 105. The plug-in heat source, the plug-in cooling source, the portable heat source, and/or the portable cooling source may also be powered via solar energy generated by the solar cell coupled to waste item receptacle 105.

In an embodiment, waste item receptacle 105 may include a renewable energy source capable of powering the waste item receptacle 105 via renewable energy. In such an embodiment, temperature sensor 110 and/or waste item receptacle computing device 115 may be powered via renewable energy generated by the renewable energy source coupled to waste item receptacle 105. The plug-in heat source, the plug-in cooling source, the portable heat source, and/or the portable cooling source may also be powered via renewable energy generated by the renewable energy source coupled to waste item receptacle 105.

In an embodiment, waste item receptacle computing device 125 may require a password be presented to waste item receptacle computing device 125 in order for an individual to engage waste item receptacle computing device 125. An individual that fails to provide the correct password to waste item receptacle computing device 125 may be prevented from engaging waste item receptacle computing device 125. Failing to provide the correct password may prevent unauthorized individuals from accessing the contents disposed into waste item receptacle 105.

In an embodiment, waste item receptacle computing device 125 may include a user interface so that an individual may engage waste item receptacle computing device 125 via the user interface. For example, the individual may selected the temperature that controller 125 is to control locally for waste item receptacle 105 via the user interface. Waste item receptacle 105 may also include an RFID tag so that waste item receptacle 105 may be tracked when waste item receptacle 105 is moved. Waste item receptacle 105 may be composed of materials that include but are not limited to plastics, steel, iron, aluminum, copper, synthetic ceramic, any hybrid material, change materials such as organic change materials, paraffin, fatty acids, inorganic materials such as salt hydrates, hygroscopic materials such as wool, eutectics, and/or any other material suitable to house waste item contents as will occur to those of skill in the art.

In an embodiment, waste item receptacle computing device 125 may be equipped with safety features such as but not limited to thermostat smoke, temperature, battery detectors, and/or sensors. These features may be added to avoid any hazardous events and to provide safety to users.

### Method of Controlling Temperature of a Waste Item Receptacle

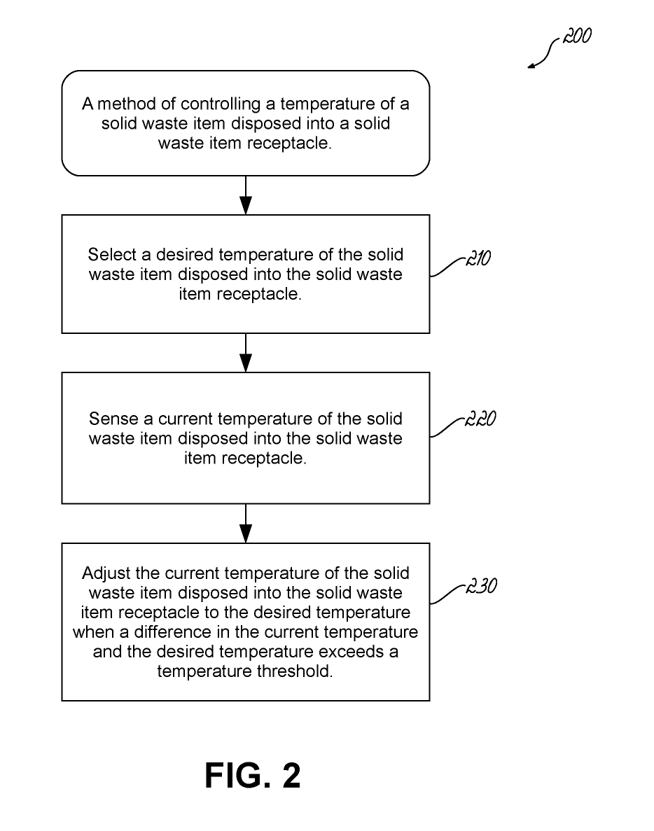

FIG. 2 is an illustration of an exemplary method 200 of controlling a temperature of contents disposed into a waste item receptacle. As shown in FIG. 2, method 200 begins at operation 210 where a desired temperature of the contents disposed into the waste item receptacle is selected. In an embodiment, as shown in FIG. 1, a controller, such as controller 125, selects a desired temperature of the contents disposed into the waste item receptacle, such as waste item receptacle 105. Once operation 210 is complete, method 200 proceeds to operation 220.

At operation 220, a current temperature of the contents disposed into the waste item receptacle is sensed. In an embodiment, as shown in FIG. 1, a temperature sensor, such as temperature sensor 110, senses a current temperature of the contents disposed into the waste item receptacle, such as waste item receptacle 105. Once operation 220 is complete, method 200 proceeds to operation 230.

At operation 230, the current temperature of the contents disposed into the waste item receptacle is adjusted to the desired temperature when a difference in the current temperature and the desired temperature exceeds a temperature threshold. In an embodiment, as shown in FIG. 1, a controller, such as controller 125, adjusts the current temperature of the contents disposed into the waste item receptacle, such as waste item receptacle 105, when a difference in the current temperature and the desired temperature exceeds a temperature threshold. Once operation 230 is completed, method 200 ends.

### Additional Applications

Waste item receptacles may be uniquely designed in a way that the temperature of waste item receptacles and contents disposed in the waste item receptacles can be controlled as per needs of users. In some embodiments, these waste item receptacles are developed to protect waste and sounding environment, people and facilities from odors, bacterial infections, contamination, diseases, bugs, flies, development of harmful cells, fire, explosion, chemical reactions etc. In some embodiments, temperature controlled waste item receptacles that are heated are developed for cold places so users can throw their food waste and organic waste and accelerate the process of composting.

Waste management becomes an issue for homeowners in warmer temperature conditions. Most homes have indoor waste item receptacles located in kitchens, bathrooms, offices, basements and/or other areas. When these waste item receptacles and the contents disposed in these waste item receptacles remain in warmer temperature conditions, the spread of bad odor, bacteria, infectious diseases, bugs, gases etc. may result. During warmer seasons, if people discard hazardous waste including sanitary napkins, diapers, and/or food scraps into waste item receptacles, the air and environment in homes can become contaminated, infectious and unhygienic. People residing in these homes such as children, senior citizens and/or sick people may be at a higher risk of susceptibility to illness that is associated with contents. Also during warmer seasons, if people discard drugs, electronic devices, chemicals, paints and other hazardous materials in indoor waste item receptacles, severe safety risks such as explosion, fire, etc may result. Many homes may be air conditioned. However, air conditioning designed for a home is often times not operated during day time since most people are at work place, schools and/or daycare. Outdoor trash cans placed in garages, gardens also may have severe safety risks. These waste item receptacles are generally limited to being picked up once a week which increases the severity of the safety risks.

Many organizations and businesses also experience all above waste management issues during warmer seasons. These issues are extremely critical for some organizations such as hospitals, healthcare facilities, nursing homes, etc. Healthcare facilities are significant producers of hazardous waste that can result in disease or injury. The hazardous nature of healthcare waste may include but not limited to infectious agents; genotoxins, hazardous chemicals, hazardous pharmaceuticals, and/or radioactive substances. Infectious waste including sharps, blood, and/or surgery room waste. Laboratories and/or research areas also have similar types of hazardous waste and face similar issues in warmer temperature conditions. Even though hospitals are air conditioned, the temperatures of various areas in the hospital vary significantly. Also, when waste is transferred from inside the hospital to disposal facilities, the waste is exposed to severe warmer weather conditions. The main groups at risk of infection solid medical waste include but are not limited medical doctors, nurses, healthcare auxiliaries, hospital maintenance individuals, patients, visitors, and/or workers at disposal facilities. Proper waste management in warmer conditions is also a significant issue for businesses including manufacturers of drugs, manufacturers of chemicals, manufacturers of electronics, construction sites, and/or government facilities etc.

There are also issues faced by institutions in extreme cold conditions. For instance, some households and businesses are encouraged to do proper discard of their organic waste through composting. However, they find it very difficult and cumbersome to do composting of organic waste. As a result, they send their organic waste to third party commercial composting facilities. If keep their organic trash is kept in cold temperatures (indoor or outdoor), it may significantly slow the degradation process of their organic waste. Thus, such individuals require that their food scrap and/or organic waste remain in room temperature and/or warmer conditions for faster degradation.

Thus, there is a need of waste item receptacles that are temperature controlled and so the temperature can be set as per need of an user. Temperature controlled waste item receptacles can effectively address the issues listed above. For instance, cold temperatures can immediately slow down the growth of bacteria, cells, diseases, bad smell etc. Also, cold temperatures can eliminate and/or minimize the risk of hazardous waste containing batteries, chemicals, drugs, etc. Thus, there is a need for various sizes of cold temperature controlled waste item receptacles that are developed for homes, businesses, organizations, and/or government facilities for indoor and/or outdoor use. Similarly, there are warm or room temperature controlled waste item receptacles for homes and businesses for indoor and/or outdoor use to dispose of organic waste scrap to increase composting cycle/timings etc.

In some embodiments, temperatures of all various types of waste item receptacles are only operated and/or controlled for cold temperatures. In some embodiments, temperatures of waste item receptacles are controlled and operated for warm temperatures. In some embodiments, temperatures of waste item receptacles are controlled and/or operated for both warm and cold types of temperatures. In some embodiments, various sizes and designs of cold temperature controlled waste item receptacles are designed for homes for use in kitchens, bathrooms, offices, etc. to discard of everyday contents. In some embodiments, various sizes and designs of cold temperature waste item receptacles are designed for disposing of diapers, sanitary napkins, etc. In some embodiments, various sizes and designs of cold temperature waste item receptacles are designed for outdoor areas of homes such as garages, gardens, etc.

In one embodiment, cold temperature controlled waste item receptacles are designed for healthcare facilities for managing pharmaceutical waste and/or medical waste. In one embodiment, cold temperature controlled waste item receptacles are designed for surgery rooms to discard blood, cells, human body parts, etc. In one embodiment, cold temperature controlled waste item receptacles are designed for facilities that discard liquid such as chemicals, drugs, etc. In one embodiment, cold temperature controlled waste item receptacles are designed for laboratories and/or research institutes to discard their including animals, cells, blood, body parts of animals, chemicals, etc. In one embodiment, cold temperature controlled waste item receptacles are designed for sites such as construction sites to discard of explosive materials, metals, etc.

In one embodiment, cold temperature controlled waste item receptacles are designed for discarding electronic waste. In some embodiments, cold temperature controlled waste item receptacles are developed for vehicles including cars, buses, airplanes, etc. In one embodiment, waste item receptacles are designed so that once contents are inserted into the waste item receptacles, the contents are locked and cannot be pulled out until the door of the waste item receptacle is opened. In some embodiments, temperature controlled waste item receptacles are given passwords so other people cannot access the materials without the information of a user. In some embodiments, temperature controlled waste item receptacles can be opened only by authorized people through badge identification.

In some embodiments, temperature controlled waste item receptacles are provided wheels for movement. In some embodiments, temperature controlled waste item receptacles may range in size from 1 lbs to 10,000 lbs. In some embodiments, the range of temperature control can be set up in a range of −20 degrees Fahrenheit to 100 degrees Fahrenheit. In some embodiments, temperature controlled waste item receptacles are opened without touch via a sensor. In some embodiments, temperature controlled waste item receptacles are opened manually. In some embodiments, temperature controlled waste item receptacles are operated via electricity with a cord, and/or cordless electricity.

In some embodiments, liners of temperature controlled waste item receptacles are developed based on the use of the waste item receptacles. For instance the liners may be composed of materials that can be recycled and/or compostable. In some embodiments, material of waste item receptacles may be include any type of plastic, metal, steel, fire proof material, temperature safe material, etc. In some embodiments, materials of temperature controlled solid item receptacles may be transparent and/or translucent. In some embodiments, certain areas of temperature controlled waste item receptacles may be transparent such as the lid, window etc.

In some embodiments, temperature controlled waste item receptacles may be coupled through software to be managed and guided via the software regarding what materials should be thrown inside each of the temperature controlled waste item receptacles. In some embodiments, temperature controlled waste item receptacles are managed through RFID tags so each can be tracked. In some embodiments, waste item receptacles within a facility are connected with a centralized system so that the temperature of each waste item receptacle may be controlled and operated for each waste item receptacle from a central location.

In some embodiments, waste item receptacles are decentralized and so that each waste item receptacle may have the temperature controlled and maintained through a decentralized system such as touch keys placed on each waste item receptacle to adjust the temperature. In some embodiments, temperature controlled waste item receptacles are given touch buttons, keys, and/or screens on each waste item receptacle to set up the temperature of each waste item receptacle. In some embodiments, temperature controlled waste item receptacles are given touch screens on lids of trash cans.

In some embodiments, several temperature controlled waste item receptacles are connected. For instance, three types of waste item receptacles may be combined jointly where a first waste item receptacle may be designated for medical waste, a second waste item receptacle may be designated for chemical waste, etc. The temperature of each joined waste item receptacle may be controlled collectively or separately for each waste item receptacle. In some embodiments, temperature controlled waste item receptacles may have pipes, trays and/or other systems to discard release of water into the waste item receptacles. In some embodiments, temperature controlled waste item receptacles may include systems to release antibacterial sprays inside the waste item receptacles to kill germs inside and/or around on the surface of the waste item receptacles.

### Conclusion

The foregoing description of the specific embodiments will so fully reveal the general nature of the present invention that others may, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not limitation, such that the terminology or phraseology of the specification is to be interpreted by the skilled artisan in light of the teachings and guidance.

Therefore, embodiments consistent with the invention may be used to provide a system of controlling a temperature of contents disposed into a waste item receptacle. In many embodiments, this may prevent the contents from becoming agitated and entering a hazardous and/or unsanitary state to individuals located within proximity of the waste item receptacle with the disposed contents. The breadth and scope of the present invention should not be limited by any of the above-described exemplary embodiments, but should be defined only in accordance with the claims and their equivalents.

1. A temperature controlled waste item receptacle, wherein a temperature is selected and maintained for contents based on requirements of an end user, comprising:
a waste item receptacle configured to house contents disposed into the receptacle;
a temperature sensor configured to sense a current temperature within the waste item receptacle; and
a controller configured to:
select the temperature for within the waste item receptacle, and
maintain the temperature within the waste item receptacle to within a threshold of the selected temperature in response to the sensed current temperature to inhibit the contents of the waste item receptacle from reaching a hazardous or unsanitary state.

2. canceled

3. The temperature controlled waste item receptacle of claim 1, wherein the controller is further configured to:
prevent the contents from combusting by maintaining the controlled temperature of the waste item receptacle; and
accelerate composting of the contents by maintaining the controlled temperature of the contents.

4. The temperature controlled waste item receptacle of claim 1, wherein the controller is further configured to:
generate warm air to maintain the controlled temperature of the waste item receptacle over an extended period of time from a plug-in heat source that the waste item receptacle is plugged into, wherein the plug-in heat source is configured to generate warm air over the extended period of time to maintain the controlled temperature; and
generate cool air to maintain the controlled temperature of the waste item receptacle over the extended period of time from a plug-in cooling source that the waste item receptacle is plugged into, wherein the plug-in cooling source is configured to generate cool air over the extended period of time to maintain the controlled temperature.

5. The temperature controlled waste item receptacle of claim 4, wherein the controller is further configured to:
generate warm air to maintain the controlled temperature of the waste item receptacle over a short period of time from a portable heat source coupled to the waste item receptacle, wherein the portable heat source is configured to accompany the waste item receptacle as the waste item receptacle is moved; and
generate cool air to maintain the controlled temperature of the waste item receptacle over the short period of time from a portable cooling source coupled to the waste item receptacle, wherein the portable cooling source is configured to accompany the waste item receptacle as the waste item receptacle is moved.

6-7. (canceled)

8. The temperature controlled waste item receptacle of claim 1, wherein the controller is further configured to collectively select a single desired temperature of a plurality of waste item receptacles, wherein the single desired temperature is selected as the single desired temperature for each of the waste item receptacles.

9. The temperature controlled waste item receptacle of claim 8, wherein the temperature sensor is further configured to collectively sense from a central location a plurality of current temperatures from the plurality of waste item receptacles.

10. The temperature controlled waste item receptacle of claim 9, wherein the controller is further configured to collectively maintain a plurality of controlled temperatures of the plurality of waste item receptacles to the single desired temperature.

11. The temperature controlled waste item receptacle of claim 8, wherein the controller is further configured to select a customized desired temperature for each waste item receptacle, wherein each customized desired temperature is selected based on the contents disposed into each waste item receptacle.

12. The temperature controlled waste item receptacle of claim 11, wherein the temperature sensor is further configured to sense the plurality of current temperatures from the each of the waste item receptacles.

13. The temperature controlled waste item receptacle of claim 12, wherein the controller is further configured to maintain each controlled temperature of each waste item receptacle within a temperature threshold of each customized desired temperature when each controlled temperature drifts away from each customized desired temperature, wherein the maintaining of each controlled temperature is limited to waste item receptacles where the difference in the customized desired temperature and the controlled temperature exceeds the temperature threshold.

14-20. (canceled)

21. A method of controlling a temperature controlled waste item receptacle, wherein a temperature is selected and maintained for contents based on requirements of an end user, comprising:
housing contents disposed into the waste item receptacle;
sensing a current temperature within the waste item receptacle;
selecting the temperature for within the waste item receptacle, and
maintaining the temperature within the waste item receptacle to within a threshold of the selected temperature in response to the sensed current temperature to inhibit the contents of the waste item receptacle from reaching a hazardous or unsanitary state.

22. (canceled)

23. The method of claim 21, wherein the controlling comprises:
preventing the contents from combusting by maintaining the controlled temperature of the waste item receptacle; and
accelerating composting of the contents by maintaining the temperature of the contents.

24. The method of claim 21, wherein the controlling further comprises:
generating warm air to maintain the controlled temperature of the waste item receptacle over an extended period of time from a plug-in heat source that the waste item receptacle is plugged into, wherein the plug-in heat source is configured to generate warm air over the extended period of time to maintain the controlled temperature; and
generating cool air to maintain the controlled temperature of the waste item receptacle over the extended period of time from a plug-in cooling source that the waste item receptacle is plugged into, wherein the plug-in cooling source is configured to generate cool air over the extended period of time to maintain the controlled temperature.

25. The method of claim 24, wherein the controlling further comprises:
generating warm air to maintain the controlled temperature of the waste item receptacle over a short period of time from a portable heat source coupled to the waste item receptacle, wherein the portable heat source is configured to accompany the waste item receptacle as the waste item receptacle is moved; and
generating cool air to maintain the controlled temperature of the waste item receptacle over the short period of time from a portable cooling source coupled to the waste item receptacle, wherein the portable cooling source is configured to accompany the waste item receptacle as the waste item receptacle is moved.

26-27. (canceled)

28. The method of claim 22, further comprising:
collectively selecting a single desired temperature of a plurality of waste item receptacles, wherein the single desired temperature is selected as the single desired temperature for each of the waste item receptacles;
collectively sensing a plurality of current temperatures within the plurality of waste item receptacles; and
collectively maintain the plurality of controlled temperatures of the plurality of waste item receptacles to the single desired temperature.

29. The method of claim 28, further comprising:
selecting a customized desired temperature for each waste item receptacle, wherein each customized desired temperature is selected based on the contents disposed into each waste item receptacle;
sensing the plurality of current temperatures from the each of the waste item receptacles; and
maintaining each controlled temperature of each waste item receptacles within a temperature threshold of each customized desired temperature when in each controlled temperature drifts away from each customized desired temperature, wherein the maintaining of each controlled temperature is limited to waste item receptacles where the difference in the customized desired temperature and the controlled temperature exceeds the temperature threshold.

30. The method of claim 22, wherein a solar cell is coupled to the waste item receptacle to provide solar power to the waste item receptacle.

31. The method of claim 30, wherein is a renewable energy source is coupled to the waste item receptacle to provide renewable energy power to the waste item receptacle.

32. The method of claim 30, wherein each waste item receptacle is associated with the landfill disposition method, the recycling disposition method, or the composition disposition method.

33. The method of claim 30, wherein the controlling comprises:
maintaining each controlled temperature of each waste item receptacle from each local temperature control system that is local to each waste item receptacle, wherein each controlled temperature is maintained for each waste item receptacle on an individual basis.

34-46. (canceled)
